(19) United States
(12) Patent Application Publication
(10) Pub. No.: US 2017/0199687 A1
(43) Pub. Date: Jul. 13, 2017

(54) MEMORY SYSTEM AND CONTROL METHOD

(71) Applicant: Kabushiki Kaisha Toshiba, Minato-ku (JP)

(72) Inventors: Shunitsu KOHARA, Yokohama (JP); Kazuya KITSUNAI, Fujisawa (JP); Satoshi ARAI, Yokohama (JP); Yoshihisa KOJIMA, Kawasaki (JP)

(73) Assignee: Kabushiki Kaisha Toshiba, Minato-ku (JP)

(21) Appl. No.: 15/255,939

(22) Filed: Sep. 2, 2016

Related U.S. Application Data
(60) Provisional application No. 62/277,509, filed on Jan. 12, 2016.

(51) Int. Cl. G06F 3/06

(52) U.S. Cl. CPC G06F 3/0619; G06F 3/0688; G06F 3/0655; G06F 3/061; G06F 3/065

(57) ABSTRACT

According to one embodiment, a memory system includes a nonvolatile first memory, a second memory, and a processor. The second memory includes a first cache area for caching in units of a data-unit. The processor transfers the first data and translation information for the first data into the first memory and performs garbage collection. The garbage collection includes first to third process. The first process is determining whether second data is valid or invalid on the basis of translation information for the second data. The second data is corresponding to the first data in the first memory. The second process is copying third data within the first memory. The third data is corresponding to the second data determined to be valid. The third process is updating translation information for the third data. The processor caches, in the first cache area, only a data-unit including translation information for the first process.

### CROSS-REFERENCE TO RELATED APPLICATIONS

This application is based upon and claims the benefit of priority from U.S. Provisional Application No. 62/277,509, filed on Jan. 12, 2016; the entire contents of which are incorporated herein by reference.

### FIELD

Embodiments described herein relate generally to a memory system and a control method.

### BACKGROUND

Conventionally, as a memory system, there is known an SSD (Solid State Drive) including a NAND-type flash memory (hereinafter, NAND memory). The SSD associates an address (hereinafter, logical address) that is used by a host to specify a logical location to the SSD, with an address (hereinafter, physical address) indicating a physical location in the NAND memory. The SSD stores association between the logical address and the physical address as translation information. The SSD has an area for caching translation information. To improve performance of the SSD, a high cache hit rate of the translation information is desired.

### BRIEF DESCRIPTION OF THE DRAWINGS

FIG. 1 is a diagram illustrating an exemplary configuration of a memory system of an embodiment;

FIG. 2 is a diagram explaining each piece of information stored in the memory system 1;

FIG. 3 is a diagram illustrating an example of a configuration of an LUT cache area of the present embodiment;

FIG. 4 is a diagram illustrating an example of cache management information;

FIG. 5 is a diagram illustrating an example of a cache content descriptor;

FIG. 6 is a diagram illustrating an example of LUT management information;

FIG. 7 is a diagram illustrating an example of a data structure of cache location information;

FIG. 8 is a diagram illustrating various types of function units that are implemented by a CPU;

FIG. 9 is a flowchart explaining a summary of garbage collection;

FIG. 10 is a flowchart explaining a part of a valid data determination process;

FIG. 11 is a flowchart explaining another part of the valid data determination process;

FIG. 12 is a flowchart explaining the other part of the valid data determination process;

FIG. 13 is a flowchart explaining an eviction process;

FIG. 14 is a flowchart explaining a part of an LUT update process for GC; and

FIG. 15 is a flowchart explaining the other part of the LUT update process for GC.

### DETAILED DESCRIPTION

In general, according to one embodiment, a memory system is connectable to a host. The memory system includes a nonvolatile first memory, a second memory, an interface, and a processor. The second memory includes a first cache area in which caching is performed in units of a data-unit. The size of the data-unit is equal to a size of cache line. The interface receives first data designated to a logical address from the host. The processor transfers the first data and translation information for the first data into the first memory and performs garbage collection. The translation information for the first data is information that associates the logical address with a location where the first data is programmed in the first memory. The garbage collection includes a first process, a second process, and a third process. The first process is determining whether second data is in a valid state or an invalid state on the basis of at least translation information for the second data. The second data is corresponding to the first data in the first memory. The second process is copying third data within the first memory. The third data is corresponding to the second data determined to be in the valid state. The third process is updating translation information for the third data. The processor caches, in the first cache area, only a data-unit including translation information for the first process.

Exemplary embodiments of a memory system and a control method will be explained below in detail with reference to the accompanying drawings. The present invention is not limited to the following embodiments.

### Embodiment

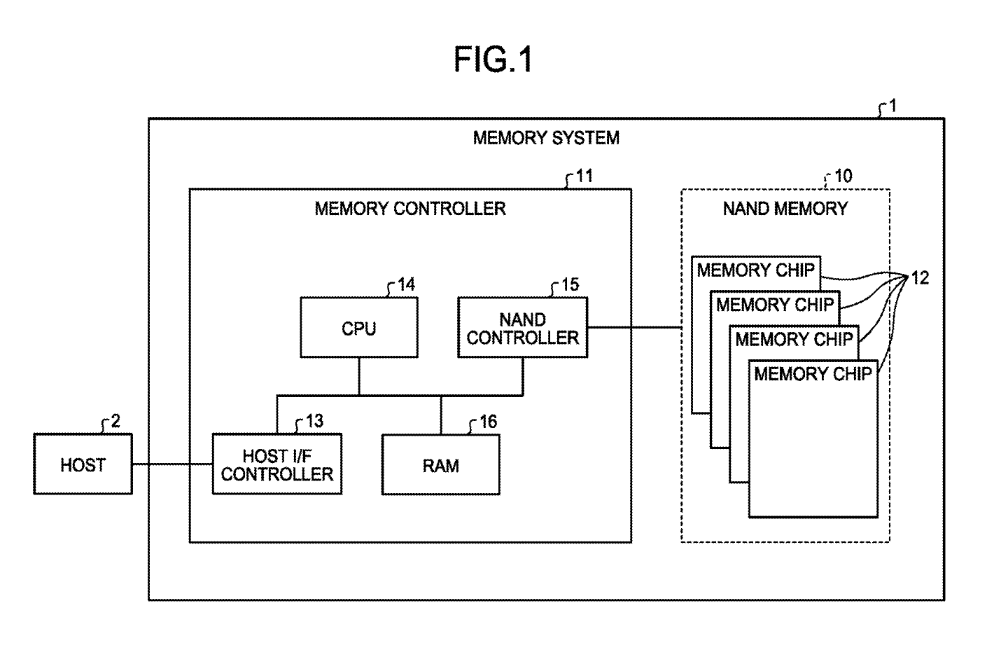

FIG. 1 is a diagram illustrating an exemplary configuration of a memory system of an embodiment. As illustrated in FIG. 1, a memory system 1 is connectable to a host 2. The host 2 has a configuration of a computer or a server. For example, an external CPU (Central Processing Unit), a personal computer, a portable information processing apparatus, a server apparatus, or the like, corresponds to the host 2. The memory system 1 functions as a storage apparatus for the host 2. The memory system 1 can receive access commands (a read command, a write command, etc.) from the host 2. The memory system 1 and the host 2 may be connected through a network. Alternatively, the memory system 1 and the host 2 may be connected by an external bus or an internal bus.

The memory system 1 provides an address space to the host 2. The address space is a range of logical addresses that can be specified by the host 2. Address information indicating a location in the address space is referred to as logical address. The host 2 specifies a logical location in the memory system 1 by using a logical address. Namely, the above-described access commands each include a logical address indicating a location of an access destination. The logical address is represented by, for example, an LBA (Logical Block Addressing) scheme.

The memory system 1 includes a NAND-type flash memory (NAND memory) 10 and a memory controller 11 that performs data transfer between the host 2 and the NAND memory 10. The NAND memory 10 includes one or more memory chips 12. Note that instead of the NAND memory 10, any type of nonvolatile memory can be employed. For example, instead of the NAND memory 10, a NOR-type flash memory or a flash memory having three-dimensional memory cells may be employed.

Each memory chip 12 includes a memory cell array. The memory cell array includes a plurality of blocks. A block is the minimum unit area of erase for the memory cell array. Each block included in the memory cell array includes a plurality of pages. A page is the minimum unit area of programming and reading for the memory cell array. A page can store a plurality of pieces of data of cluster size. A cluster is the minimum unit in which translation between a logical address and a physical address can be performed by translation information.

The memory controller 11 includes a host interface controller (host I/F controller) 13, a CPU 14, a NAND controller 15, and a RAM (Random Access Memory) 16. They are connected to each other by a bus.

The RAM 16 is used as an area that temporarily stores various kinds of data. As the RAM 16, a DRAM (Dynamic Random Access Memory) or an SRAM (Static Random Access Memory) can be employed. Alternatively, instead of the RAM 16, any volatile or nonvolatile memory that is faster in accessing than the NAND memory 10 can be employed.

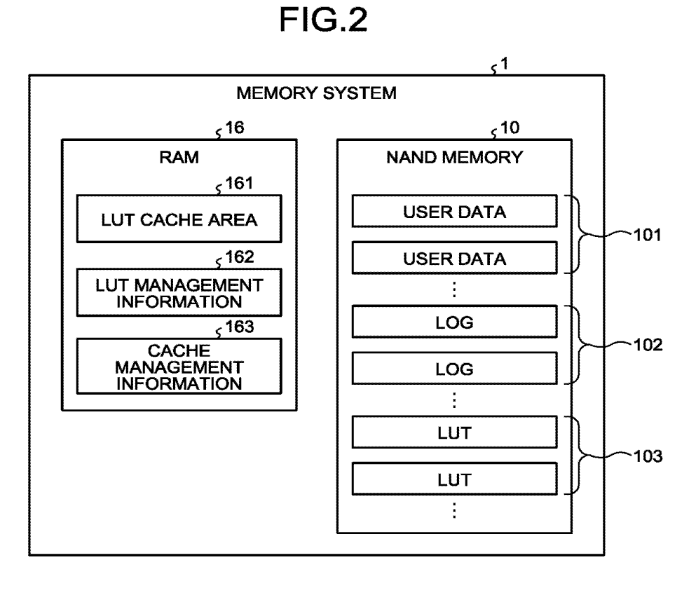

FIG. 2 is a diagram explaining each piece of information to be stored in the memory system 1.

In the NAND memory 10 are stored at least user data 101, one or more logs 102, and one or more LUTs (lookup tables) 103. The user data 101 is data transmitted with a write command from the host 2, and is data programmed in the NAND memory 10. A plurality of pieces of user data 101 can be stored in the NAND memory 10. Each piece of user data 101 is programmed in the NAND memory 10 in a log-structured manner.

An LUT 103 is a group of information including a plurality of pieces of address translation information, each associating a logical address with a physical address, and is a data unit having the same size as the line size of cache areas (a first cache area 171 and a second cache area 172) which will be described later. In the cache areas, caching can be performed in units of LUTs 103. An LUT 103 associates logical addresses of a predetermined number of clusters included in a corresponding region with physical addresses. A region is consecutive unit areas in the logical address space, and is unit areas including the predetermined number of clusters. Each region is identified by a region number. A region number can be obtained by, for example, dividing a logical address by the predetermined number. For the data structure of the LUT 103, any data structure can be employed. For example, in an LUT 103, physical addresses in units of clusters are recorded in order of their corresponding logical addresses. A plurality of LUTs 103 can be stored in the NAND memory 10. Each LUT 103 is programmed in the NAND memory 10 in a log-structured manner.

A log 102 is information generated in response to programming of user data 101 in the NAND memory 10, and is programmed in the NAND memory 10. A log 102 is information that associates, in units of clusters, a physical address indicating a physical location in the NAND memory 10 where user data 101 is programmed, with a logical address that is used to specify a logical location of the user data 101. In other words, the log 102 represents the association between the physical address indicating the location where the user data 101 is programmed in the NAND memory, and the logical address used to specify the location of the user data 101 in the memory system 1. Here, as an example, the log 102 includes a pair of the physical address indicating the location where user data 101 is programmed in the NAND memory 10, and the logical address used to specify the location of the user data 101 in the memory system 1. It is assumed that the correspondence between the user data 101 and the log 102 generated in response to the programming the user data 101 is statically determined using a predetermined technique. A plurality of logs 102 can be stored in the NAND memory 10. Each log 102 is programmed in the NAND memory 10 in a log-structured manner.

Note that there is a method in which logs 102 associated with pieces of user data 101, respectively, are stored in the same order as the order in which the pieces of user data 101 are stored. According to such a method, locations where the pieces of user data 101 are programmed statically correspond to locations where the logs 102 are programmed. In such a case, it is possible to derive, from a location of each log 102, a physical address indicating a location where a piece of corresponding user data 101 is programmed. Namely, a physical address does not necessarily need to be explicitly recorded in the log 102.

An LUT cache area 161 is allocated in the RAM 16. The RAM 16 further stores an LUT management information 162 and cache management information 163.

The LUT cache area 161 is an area where LUTs 103 are cached.

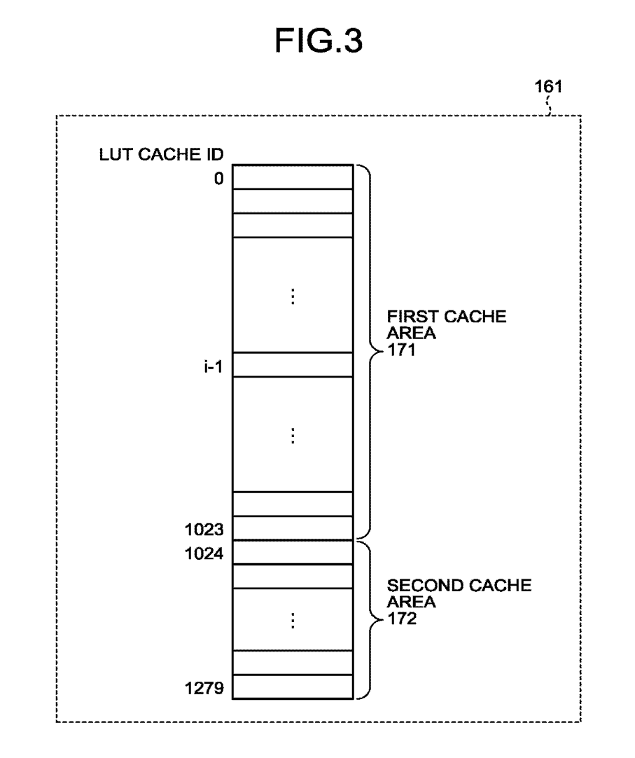

FIG. 3 is a diagram illustrating an example of a configuration of the LUT cache area 161 of the present embodiment. The LUT cache area 161 includes a plurality of areas, each capable of storing an LUT 103. Each of the plurality of areas in the LUT cache area 161 is identified by an LUT cache ID. Here, as an example, in the LUT cache area 161, an i-th area (i is an integer greater than or equal to 1) from the head area which is assigned the LUT cache ID “0” is assigned the LUT cache ID “i−1”.

The LUT cache area 161 includes a first cache area 171 which is a cache area for garbage collection (GC); and a second cache area 172 which is cache area for other processes. The garbage collection will be described later. Here, as an example, areas with the LUT cache IDs “0” to “1023” correspond to the first cache area 171, and areas with the LUT cache IDs “1024” to “1279” correspond to the second cache area 172. Each of the first cache area 171 and the second cache area 172 may be a logically contiguous area or a physically contiguous area. Each of the first cache area 171 and the second cache area 172 may be allocated dynamically or statically.

Eviction of an LUT 103 is performed independently in the first cache area 171 and the second cache area 172. As an eviction scheme, any scheme can be employed. Here, loading and eviction are performed by a FIFO (first-in first-out) scheme, individually in the first cache area 171 and the second cache area 172. Namely, the first cache area 171 and the second cache area 172 each have a FIFO structure.

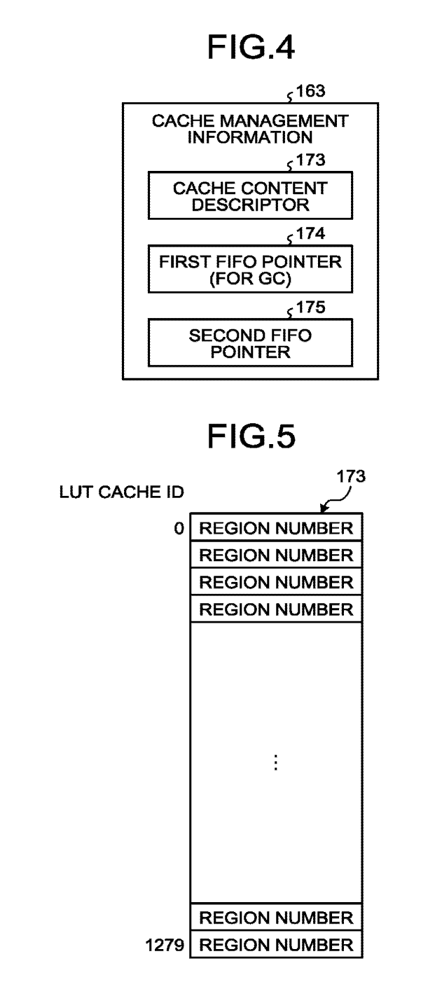

The cache management information 163 is management information for using the LUT cache area 161 as a FIFO structure. FIG. 4 is a diagram illustrating an example of the cache management information 163. The cache management information 163 includes cache content descriptor 173, a first FIFO pointer 174, and a second FIFO pointer 175.

FIG. 5 is a diagram illustrating an example of the cache content descriptor 173. The cache content descriptor 173 has a data structure capable of storing a plurality of region numbers. Each element in the cache content descriptor 173 corresponds one-to-one with each area capable of storing an LUT 103 in the LUT cache area 161, through an LUT cache ID. An i-th element (i is an integer greater than or equal to 1) from the head of the cache content descriptor 173 corresponds to the LUT cache ID “i−1”. A region number stored in each element in the cache content descriptor 173 indicates a region associated with an LUT 103 that is cached in a corresponding area in the LUT cache area 161.

The first FIFO pointer 174 is a pointer indicating a location where loading based on a FIFO manner to the first cache area 171 can be performed. Namely, the first FIFO pointer 174 indicates the logical tail of information loaded to the first cache area 171 serving as a FIFO structure. The second FIFO pointer 175 is a pointer indicating a location where loading based on a FIFO manner to the second cache area 172 can be performed. Namely, the second FIFO pointer 175 indicates the logical tail of information loaded to the second cache area 172 serving as a FIFO structure. The first FIFO pointer 174 is incremented every time loading to the first cache area 171 has been performed. The second FIFO pointer 175 is incremented every time loading to the second cache area 172 is performed. Each FIFO pointer goes back to the head of a corresponding cache area after reaching the logical tail of the corresponding cache area. Namely, each cache area is used as a ring buffer in practice. According to this example, the first FIFO pointer 174 is operated in a range from the LUT cache ID “0” to the LUT cache ID “1023”, and the second FIFO pointer 175 is operated in a range from the LUT cache ID “1024” to the LUT cache ID “1279”. In addition, here, as an example, in each cache area (the first cache area 171 and the second cache area 172), loading and eviction are performed at once.

The LUT management information 162 is information including, for each region forming the logical address space, at least (1) whether an LUT 103 is cached in the LUT cache area 161, and (2) if the LUT 103 is cached in the LUT cache area 161, a location where the LUT 103 is cached and a status of the LUT 103, a location in the NAND memory 10 where the LUT 103 is stored. Examples of the status will be described later.

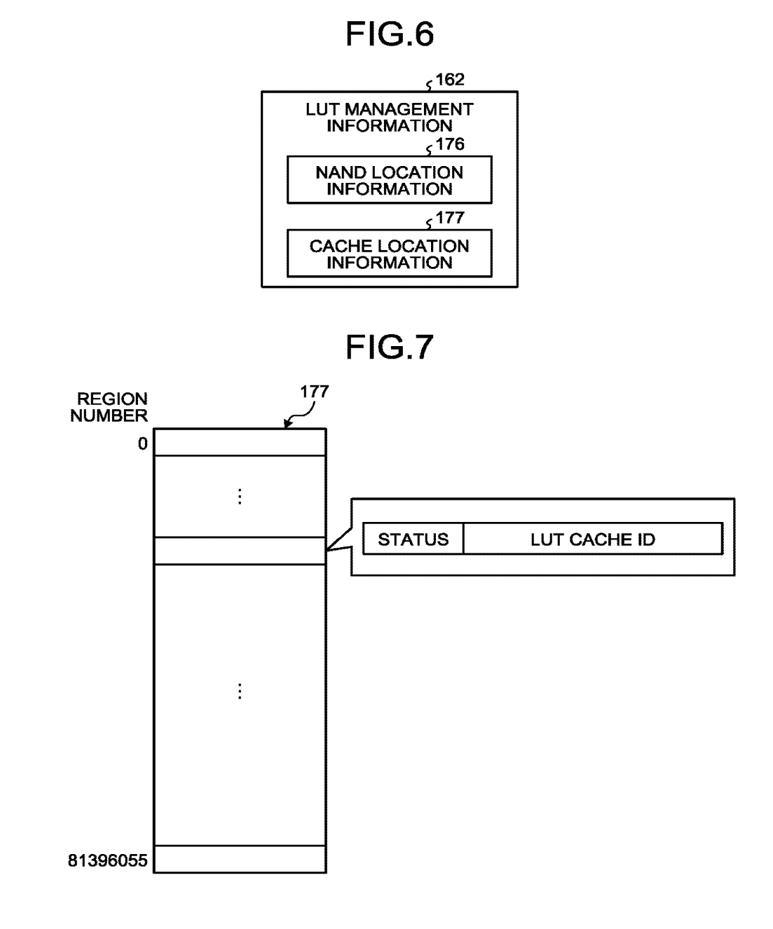

FIG. 6 is a diagram illustrating an example of the LUT management information 162. The LUT management information 162 includes NAND location information 176 and cache location information 177.

The NAND location information 176 includes, for each region included in the address space, a physical address indicating a location where a corresponding LUT 103 is stored in the NAND memory 10. In a state in which an LUT 103 related to a given region is stored in a first location in the NAND memory 10 and the first location is recorded in the NAND location information 176, when another LUT 103 related to the region is added to a second location in the NAND memory 10, the first location recorded in the NAND location information 176 is updated to the second location. Namely, the NAND location information 176 indicates, for each region included in the address space, a location of an LUT 103 that is programmed last among one or more LUTs 103 programmed in the NAND memory 10.

The cache location information 177 is information including, for each region included in the address space, a status; and, when an LUT 103 is cached in the LUT cache area 161, a location in the LUT cache area 161 where the LUT 103 is cached.

FIG. 7 is a diagram illustrating an example of a data structure of the cache location information 177. As illustrated in the drawing, data including a status and an LUT cache ID indicating a location where an LUT 103 is cached is arranged in order of region numbers. Note that the location where the LUT 103 is cached may be represented by any other information instead of the LUT cache ID. Here, as an example, a status includes “NOT-CACHED”, “CACHED”, AND “READING”. The status “NOT-CACHED” means that the LUT 103 is not cached in the LUT cache area 161. The status “CACHED” means that the LUT 103 is cached in the LUT cache area 161. The status “READING” means that the LUT 103 is being transferred from the NAND memory 10 to the LUT cache area 161.

The host I/F controller 13 controls communication between the host 2 and the memory controller 11 under control of the CPU 14. The host I/F controller 13 can receive commands transmitted from the host 2. The host I/F controller 13 can receive user data associated with a write command transmitted from the host 2. The host I/F controller 13 can transmit, to the host 2, user data 101 that is read from the NAND memory 10 in response to a read command.

The NAND controller 15 performs access to the NAND memory 10 under control of the CPU 14. The access includes programming, reading, and erasing.

The CPU 14 operates on the basis of a firmware program. For example, the firmware program is pre-stored in the NAND memory 10. The CPU 14 loads the firmware program into the RAM 16 from the NAND memory 10 at startup. The CPU 14 executes the firmware program loaded into the RAM 16 and thereby functions as various kinds of function units.

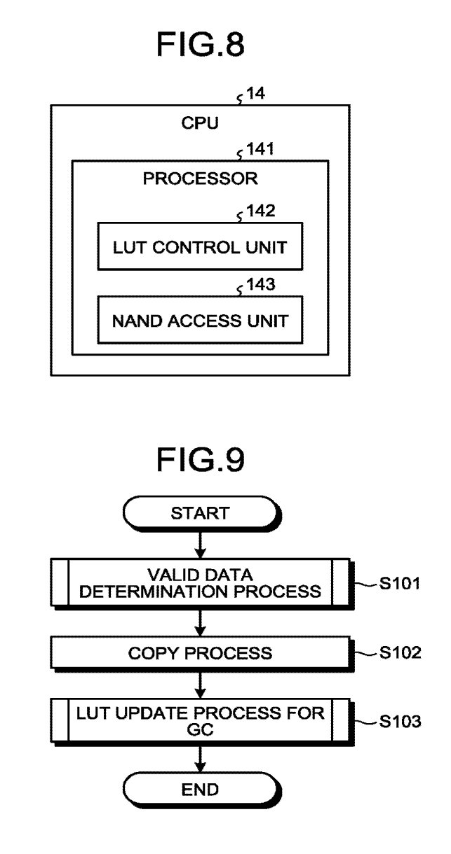

FIG. 8 is a diagram illustrating various kinds of function units that are implemented by the CPU 14 executing the firmware. The CPU 14 functions as a processor 141 that controls the memory controller 11. The processor 141 includes an LUT control unit 142 and a NAND access unit 143.

Note that some or all of the functions of the processor 141 may be implemented by a hardware circuit instead of the CPU 14 that executes the firmware. For example, the memory controller 11 may include an FPGA (field-programmable gate array) or an ASIC (application specific integrated circuit), and some or all of the functions of the processor 141 may be performed by the FPGA or ASIC.

The LUT control unit 142 performs an update and reference to the LUTs 103. The LUT control unit 142 performs, as part of an update and reference to an LUT 103, for example, control of loading of an LUT 103 to the LUT cache area 161, control of eviction of an LUT 103 from the LUT cache area 161, an update to the cache location information 177 in response to the loading and eviction of the LUTs 103 to/from the LUT cache area 161, and an update to the NAND location information 176 in response to transfer of the LUT 103 from the LUT cache area 161 to the NAND memory 10.

The NAND access unit 143 controls the NAND controller 15 to perform access to the NAND memory 10. The NAND access unit 143 particularly performs programming and read of user data 101, logs 102, and LUTs 103.

The processor 141 writes user data 101 transmitted from the host 2, to the NAND memory 10. A process of writing user data 101 transmitted from the host 2, to the NAND memory 10 is referred to as a host write (HW) process. The host write involves a process of programming user data 101 transmitted from the host 2 into the NAND memory 10 (HW programming process) and a process of updating the LUT cache area 161 (LUT update process for HW).

An example of the host write process will be explained below. A case is considered where first user data 101 designated to a first logical address had been received, then second user data 101 designated to the first logical address has been received.

The NAND access unit 143 first performs an HW programming process. Specifically, the NAND access unit 143 programs the second user data 101 in a block having a blank page, and programs, in the NAND memory 10, a log 102 that associates the location (physical address) where the second user data 101 is programmed with the first logical address. The NAND access unit 143 notifies the LUT control unit 142 of the location (physical address) where the second user data 101 is programmed, and the logical address.

The LUT control unit 142 performs an LUT update process for HW for updating a target LUT 103, in response to the notification of the location (physical address) where the second user data 101 is programmed and the logical address. In this case, the target LUT 103 is an LUT 103 associated with a region including the first logical address. In the LUT update process for HW, first, the LUT control unit 142 determines whether the target LUT 103 is cached in the LUT cache area 161.

If the target LUT 103 is cached in the LUT cache area 161, the LUT control unit 142 updates the target LUT 103 in the LUT cache area 161. Specifically, the LUT control unit 142 overwrites a location associated with the first logical address included in the target LUT 103 in the LUT cache area 161 (the location of the first user data 101) with the location of the second user data.

If the target LUT 103 is not cached in the LUT cache area 161, the NAND access unit 143 transfers the target LUT 103 from the NAND memory 10 to the second cache area 172, and thereafter, the LUT control unit 142 updates the target LUT 103 in the second cache area 172.

Upon the transfer of the LUT 103, the LUT control unit 142 identifies a location (physical address) of a transfer source of the target LUT 103, on the basis of the NAND location information 176 and notifies the NAND access unit 143 of the location. In addition, the LUT control unit 142 identifies a location (LUT cache ID) of a transfer destination of the target LUT 103, on the basis of the second FIFO pointer 175 and notifies the NAND access unit 143 of the location. The NAND access unit 143 transfers the target LUT 103 from the notified location of the transfer source to the notified location of the transfer destination. In addition, in the beginning the transfer of the target LUT 103, the LUT control unit 142 sets “READING” in the cache location information 177, as a status of the region including the first logical address. In addition, when the transfer of the target LUT 103 is completed, the LUT control unit 142 sets “CACHED” in the cache location information 177, as a status of the region including the first logical address, and updates a physical address associated with the first logical address in the target LUT 103 in the second cache area 172. The expression “updates a physical address associated with the first logical address” specifically means overwriting of the location of the first user data 101 associated with the first logical address, with the location of the second user data 101.

Note that by the update of an LUT 103 in the LUT cache area 161, the LUT 103 in the LUT cache area 161 becomes dirty. The dirty state means a state in which, for LUTs 103 related to the identical region, content of the LUT 103 in the LUT cache area 161 (the LUT 103 stored in a location indicated by the cache location information 177) and content of the LUT 103 in the NAND memory 10 (the LUT 103 stored in a location indicated by the NAND location information 176) are different from each other. The processor 141 programs the dirty LUT 103 cached in the LUT cache area 161 in the NAND memory 10 in a log-structured manner, and thereby cleans the dirty LUT 103 in the LUT cache area 161. In the present embodiment, a mechanism and timing for transitioning the state of the dirty LUT 103 in the LUT cache area 161 to clean are not particularly restricted. The clean state means a state in which, for LUTs 103 related to the identical region, content in the LUT 103 in the LUT cache area 161 (the LUT 103 stored in a location indicated by the cache location information 177) and content in the LUT 103 in the NAND memory 10 (the LUT 103 stored in a location indicated by the NAND location information 176) are same.

In addition, in the LUT update process for HW, before the processor 141 transfers the target LUT 103 from the NAND memory 10 to the second cache area 172, the processor 141 performs eviction of an LUT 103 stored in the above-described transfer destination. Note that when the LUT 103 stored in the above-described transfer destination is dirty, eviction is performed after the LUT 103 stored in the above-described transfer destination becomes clean.

By the above-described host write process, the NAND memory 10 retains, as the user data 101 designated to the first logical address, two pieces of user data 101: the first user data 101 and the second user data 101. After updating the target LUT 103, the first logical address is associated with the location of the second user data 101 instead of the location of the first user data 101. The state of user data 101 stored in a location that is associated with a logical address by an LUT 103 like the second user data 101 is referred to as valid. In addition, the state of user data 101 stored in a location that is not associated with a logical address by the latest LUT 103 like the first user data 101 is referred to as invalid. In other words, the valid state means the state of a piece of user data 101 in which other pieces of user data 101 designated to the same logical address are not present in the memory system 1, or, when other pieces of user data 101 designated to the same logical address are present in the memory system 1, the state of a piece of user data 101 that is received last among all of the pieces of user data 101 which are designated to the same logical address. In addition, the invalid state means, when other pieces of user data 101 designated to the same logical address are present in the memory system 1, the state of a piece of user data 101 other than a piece of user data 101 that is received last among all of the pieces of user data 101 designated to the same logical address.

The processor 141 reads user data 101 from the NAND memory 10 in response to a read command transmitted from the host 2. A process of reading user data 101 from the NAND memory 10 in response to a read command is referred to as a host read (HR) process. The host read process involves a process of translating a logical address specified by The read command into a physical address by referring to an LUT 103 (HR LUT reference process) and a process of reading user data 101 from the NAND memory 10 (HR read process).

An example of the host read process will be explained below. A case is considered in which a read command designating to a range including a second logical address is received from the host 2.

The LUT control unit 142 performs an HR LUT reference process for referring to a target LUT 103, in response to reception of the read command. In this case, the target LUT 103 is an LUT 103 associated with a region including the second logical address. In the HR LUT reference process, first, the LUT control unit 142 determines whether the target LUT 103 is cached in the LUT cache area 161.

If the target LUT 103 is cached in the LUT cache area 161, the LUT control unit 142 obtains a physical address associated with the second logical address, on the basis of the target LUT 103 in the LUT cache area 161. The LUT control unit 142 notifies the NAND access unit 143 of the obtained physical address.

If the target LUT 103 is not cached in the LUT cache area 161, the NAND access unit 143 transfers the target LUT 103 from the NAND memory 10 to the LUT cache area 161 (specifically, the second cache area 172). Thereafter, the LUT control unit 142 obtains a physical address associated with the second logical address, on the basis of the transferred target LUT 103 in the LUT cache area 161. The LUT control unit 142 notifies the NAND access unit 143 of the obtained physical address.

Upon the transfer of the LUT 103, the LUT control unit 142 identifies a location (physical address) of a transfer source of the target LUT 103 on the basis of the NAND location information 176 and notifies the NAND access unit 143 of the location. In addition, the LUT control unit 142 identifies a location (LUT cache ID) of a transfer destination of the target LUT 103 on the basis of the second FIFO pointer 175 and notifies the NAND access unit 143 of the location. In addition, at the start of the transfer of the target LUT 103, the LUT control unit 142 sets “READING” in the cache location information 177, as a status of the region including the second logical address. In addition, when the transfer of the target LUT 103 is completed, the LUT control unit 142 sets “CACHED” in the cache location information 177, as a status of the region including the second logical address.

In addition, in the HR LUT reference process, before the processor 141 transfers the target LUT 103 from the NAND memory 10 to the second cache area 172, the processor 141 performs eviction of an LUT 103 stored in the transfer destination. When the LUT 103 stored in the location of the transfer destination is dirty, the NAND access unit 143 programs the LUT 103 stored in the location of the transfer destination, in the NAND memory 10 in a log-structured manner, and the LUT control unit 142 updates the NAND location information 176, and thereafter, the LUT control unit 142 deletes the LUT 103 stored in the transfer destination from the second cache area 172.

As described above, in a host write process and a host read process, when a target LUT 103 is not cached in the LUT cache area 161, the processor 141 loads the target LUT 103 to the second cache area 172. Note that the details of techniques for a host write process and a host read process are not limited to only the techniques explained above.

The processor 141 further performs garbage collection for the purpose of producing free blocks. The garbage collection means a process of moving (copying) valid user data 101 from one move source to a blank area in another block and thereafter invalidating all data stored in the move source block by updating a corresponding LUT 103. More specifically, the garbage collection includes a process of identifying valid user data 101 in a move source block (valid data determination process), a copy process of copying the identified valid user data 101 from the move source block to a move destination block in the NAND memory 10, and a process of updating a corresponding LUT 103 in response to the copying of the user data 101 (LUT update process for GC). The move source block becomes a free block after the garbage collection. The free block becomes a programmable state where no data is stored, by performing an erasing. The free block can be used as a move destination block in the garbage collection. In addition, the free block can be used as a programming destination block in a host write process.

In the valid data determination process, a target LUT 103 is loaded to the first cache area 171. In the LUT update process for GC, the target LUT 103 is updated in the first cache area 171. In this case, the target LUT 103 is an LUT 103 associated with a region including a logical address indicating a location of user data 101 that is determined, in the valid data determination process, to be valid among a plurality of pieces of user data 101 stored in a move source block. Since the loading to the first cache area 171 is performed only in the garbage collection, eviction of an LUT 103 from the first cache area 171 is not performed by other processes than the garbage collection. Therefore, by appropriately configuring the size of the first cache area 171, it is possible to achieve a high cache hit ratio in the LUT update process for GC. Note that the first cache area 171 may be used for any operation other than the garbage collection after the startup of the memory system 1 until the garbage collection is started.

Garbage collection of the present embodiment will be explained in detail below.

FIG. 9 is a flowchart explaining a summary of garbage collection. First, the processor 141 performs a valid data determination process (S101). Then, the processor 141 performs a copy process of copying valid user data 101 stored in a move source block to a move destination block (S102). Then, the processor 141 performs an LUT update process for GC in response to the copy process (S103), and ends the garbage collection.

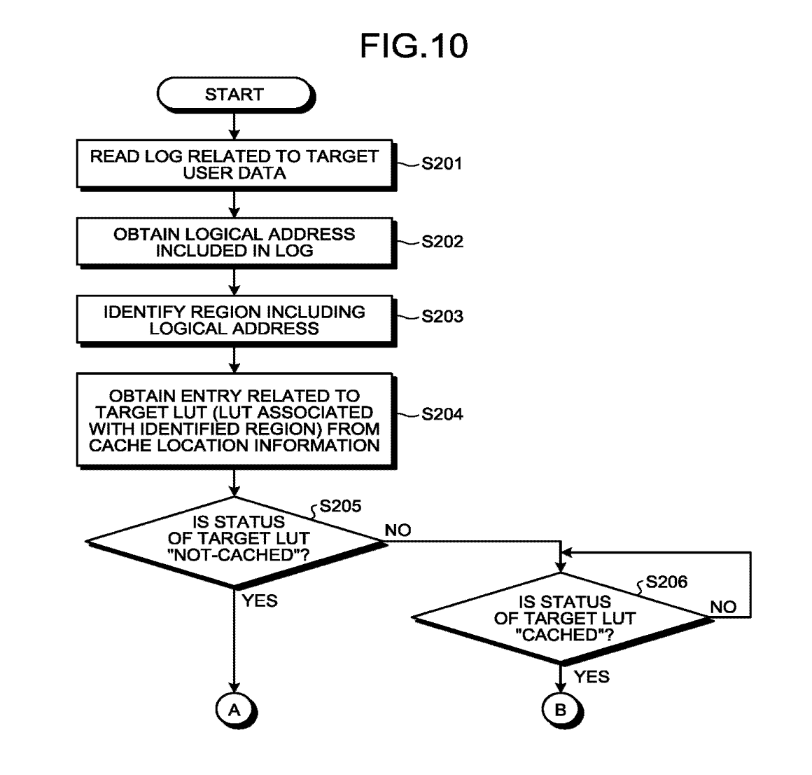

FIGS. 10, 11, and 12 are flowcharts explaining the valid data determination process. Here, for simplicity, an explanation will be made on only a process for one piece of user data 101 (target user data 101 in the explanation of FIGS. 10 to 12) among a plurality of pieces of user data 101 stored in a move source block. In practice, the processes of FIGS. 10 to 12 are performed for all user data 101 stored in the move source block.

As illustrated in FIG. 10, first, the NAND access unit 143 reads a log 102 that had been programmed in response to programming of target user data 101 (S201). The log 102 includes a logical address specified when the target user data 101 had been transmitted from the host 2; and a location (physical address) where the target user data 101 had been programmed. The LUT control unit 142 obtains the logical address from the log (S202).

The LUT control unit 142 identifies a region including the logical address which is obtained by the process at S202 (S203). In the explanation of FIGS. 10 to 12, an LUT 103 associated with the region that is identified by the process at S203 is referred to as target LUT 103. The LUT control unit 142 obtains an entry related to the target LUT 103 from the cache location information 177 (S204). The LUT control unit 142 determines whether or not the status of the target LUT 103 is “NOT-CACHED”, by referring to the obtained entry (S205).

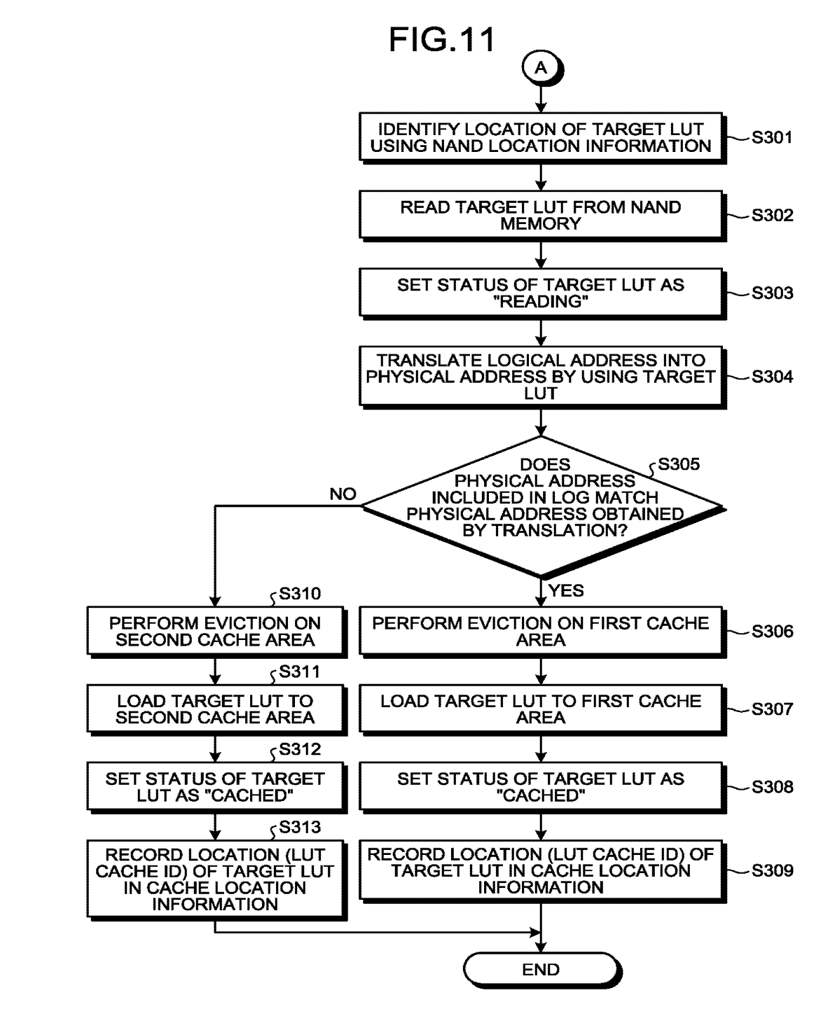

If the status of the target LUT 103 is “NOT-CACHED” (S205, Yes), as illustrated in FIG. 11, the LUT control unit 142 identifies a location where the target LUT 103 had been programmed, by referring to the NAND location information 176 (S301). The identified location is transferred to the NAND access unit 143, and the NAND access unit 143 reads the target LUT 103 from the identified location (S302). The target LUT 103 read by the process at S302 is stored in a temporary area such as the RAM 16. The LUT control unit 142 sets the status of the target LUT 103 as “READING” (S303). In addition, the LUT control unit 142 translates the logical address included in the log 102 into a physical address by using the read target LUT 103 (S304). Then, the LUT control unit 142 determines whether or not the physical address included in the log 102 matches the physical address obtained by the translation (S305).

The process at S305 is a process of determining whether or not translation information of the target user data 101 matches the target log 102. The translation information matching the log 102 means that an association between a logical address and a physical address represented by the translation information matches an association between a logical address and a physical address represented by the log 102. The translation information not matching the log 102 means that the association between a logical address and a physical address represented by the translation information does not match the association between a logical address and a physical address represented by the log 102. For user data 101 programmed in a location indicated by a given physical address, the fact that translation information matches a log 102 means that the user data 101 is valid. The fact that the translation information does not match the log 102 means that the user data 101 is invalid.

At the process at S305, the fact that the physical address included in the log 102 matches the physical address obtained by the translation means that the translation information of the target user data 101 has not been updated from the timing of generation of the log 102 up until the timing of S305, and thus means that the target user data 101 is valid. The fact that the physical address included in the log 102 does not match the physical address obtained by the translation means that the translation information of the target user data 101 had been updated from the timing of generation of the log 102 up until the timing of S305, and thus means that the target user data 101 is invalid.

If the physical address included in the log 102 matches the physical address obtained by the translation (S305, Yes), the LUT control unit 142 performs eviction on the first cache area 171 (S306).

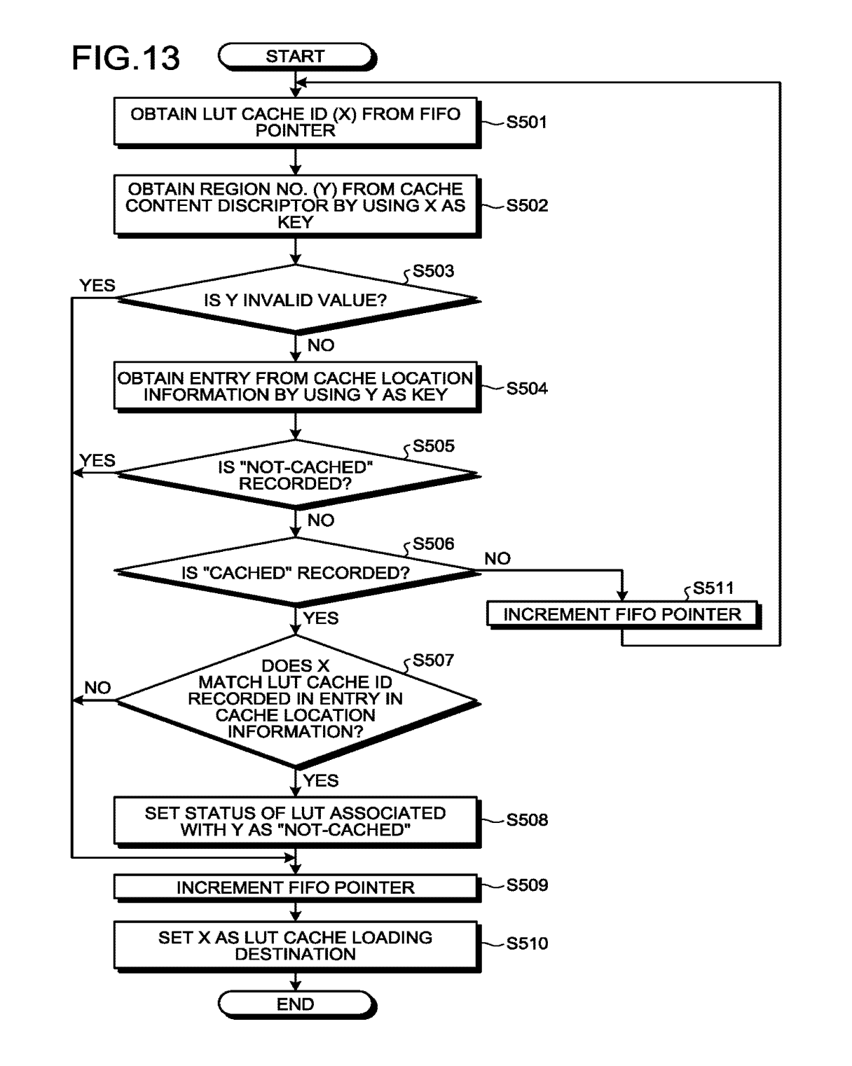

FIG. 13 is a flowchart explaining an eviction process. Note that a series of processes illustrated in the drawing are applied to both cases: eviction on the first cache area 171 and eviction on the second cache area 172. Note, however, that in the case of eviction on the first cache area 171, the first FIFO pointer 174 is used, and in the case of eviction on the second cache area 172, the second FIFO pointer 175 is used. Here, eviction on the first cache area 171 will be explained.

First, the LUT control unit 142 obtains an LUT cache ID by referring to the first FIFO pointer 174 (S501). The LUT cache ID obtained by the process at S501 is represented as “X”. The LUT control unit 142 obtains A region number from the cache content descriptor 173 by using “X” as a key (S502). The region number obtained by the process at S502 is represented as “Y”. The LUT control unit 142 determines whether or not “Y” is an invalid value (S503).

The invalid value is a magic number meaning that an LUT 103 is not stored (i.e. not immediately available) in a corresponding area (in the example of FIG. 13, an area indicated by the LUT cache ID “X”) in the cache area. For example, after startup of the memory system 1, a first cache area 171 is allocated and a cache content descriptor 173 is generated. Invalid values are recorded in all entries in the generated cache content descriptor 173 in an initialization process. In response to loading of an LUT 103 to a corresponding area in the first cache area 171, an invalid value recorded in the cache content descriptor 173 is updated to a region number indicating a region associated with the loaded LUT 103. When an unused area remains in the first cache area 171 after startup of the memory system 1, an invalid value remains, as a region number, in an entry in the cache content descriptor 173 that corresponds to the unused area.

If “Y” is not an invalid value (S503, No), the LUT control unit 142 obtains an entry from the cache location information 177 by using “Y” as a key (S504). The LUT control unit 142 determines whether or not “NOT-CACHED” is recorded in the entry obtained from the cache location information 177 (S505). If “NOT-CACHED” is not recorded in the entry obtained from the cache location information 177 (S505, No), the LUT control unit 142 determines whether or not “CACHED” is recorded in the entry obtained from the cache location information 177 (S506).

If “CACHED” is recorded in the entry obtained from the cache location information 177 (S506, Yes), the LUT control unit 142 determines whether or not an LUT cache ID that is recorded in the entry obtained by the process at S504 in the cache location information 177 matches “X” (S507).

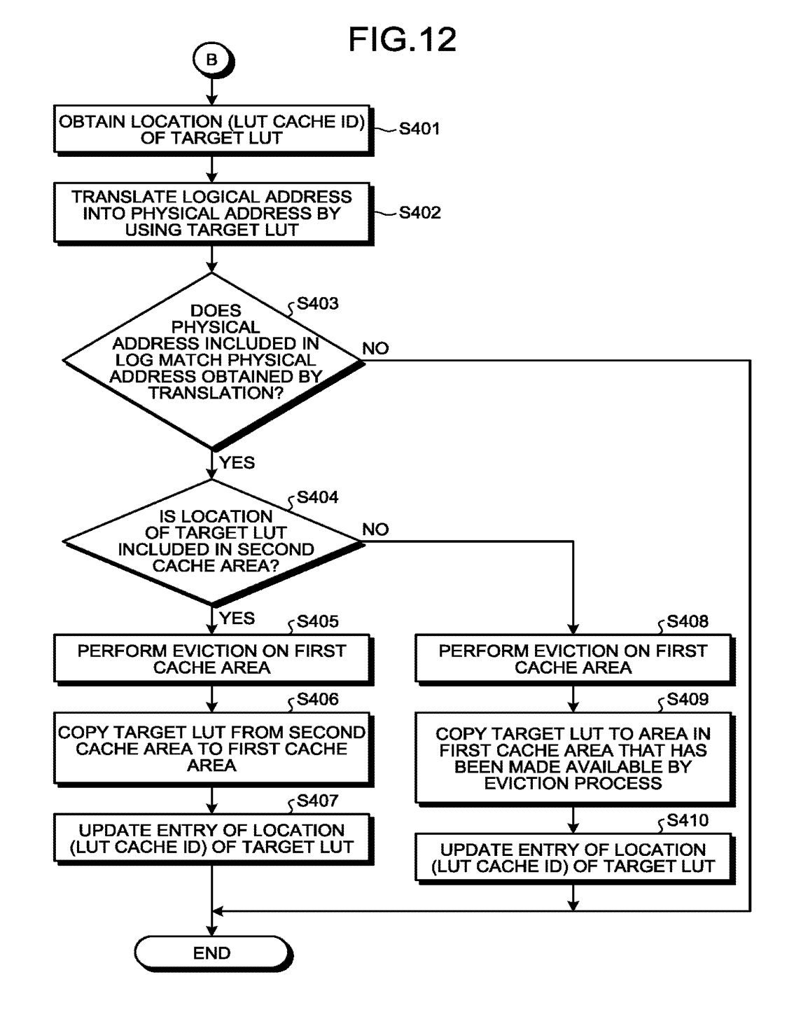

The LUT 103 in the cache area can be copied between areas by a process (S406 or S409 in FIG. 12) which will be described later. As a result of the copying, identical region numbers are retained in multiple entries in the cache content descriptor 173. On the other hand, the cache location information 177 is configured to be able to uniquely identify a location (LUT cache ID) of the current (the most recent instance of) LUT 103 associated with each region. When the cache content descriptor 173 includes multiple entries indicating the same region, an entry that is associated with the region by the cache location information 177 among the multiple entries is a current (latest) entry for the region. Among the multiple entries, an entry that is not associated with the region by the cache location information 177 is not a current entry for the region. The process at S507 is a process for determining whether or not an LUT 103 cached in a location indicated by the first FIFO pointer 174 is adapted to the current state.

If an LUT cache ID that is recorded in the entry obtained by the process at S504 in the cache location information 177 matches “X” (S507, Yes), the LUT control unit 142 sets the status of an LUT 103 associated with a region with the region number “Y” asFS604 “NOT-CACHED” (S508). Then, the LUT control unit 142 increments the first FIFO pointer 174 (S509), obtains “X” as a location where loading of an LUT 103 can be performed (S510), and ends the eviction process.

If “Y” is an invalid value (S503, Yes), or if “NOT-CACHED” is recorded in the entry obtained from the cache location information 177 (S505, Yes), or if an LUT cache ID that is recorded in the entry obtained from the cache location information 177 does not match “X” (S507, No), the LUT control unit 142 performs the process at S509.

If “CACHED” is not recorded in the entry obtained from the cache location information 177 (S506, No), i.e., “READING” is recorded in the entry obtained from the cache location information 177, the LUT control unit 142 increments the first FIFO pointer 174 (S511), and performs the process at S501.

Referring back to the explanation of FIG. 11, when the LUT control unit 142 performs eviction on the first cache area 171 in the process at S306, the LUT control unit 142 obtains an LUT cache ID by the process at S510. The LUT cache ID obtained by the process at S510 indicates a location where loading of an LUT 103 can be performed. The LUT control unit 142 loads the target LUT 103 to a location in the first cache area 171 that is indicated by the LUT cache ID obtained by the process at S510 (S307). In the process of S307, the LUT control unit 142 updates the cache content descriptor 173 in response to the loading the target LUT 103. In particular, the LUT control unit 142 registers a region number of the identified region to a location corresponding to the loading destination of the target LUT 103. The LUT control unit 142 sets the status of the target LUT 103 as “CACHED” (S308), records, in the cache location information 177, the location (LUT cache ID “X”) of the target LUT 103 in the first cache area 171 (S309), and ends the valid data determination process.

On the other hand, if the physical address included in the log 102 does not match the physical address obtained by the translation (S305, No), the LUT control unit 142 performs eviction on the second cache area 172 (S310). The LUT control unit 142 loads the target LUT 103 to a location in the second cache area 172 (S311). In the process of S311, the LUT control unit 142 updates the cache content descriptor 173 in the same way as the process of S307. Then the LUT control unit 142 sets the status of the target LUT 103 as “CACHED” (S312), records, in the cache location information 177, the location (LUT cache ID “X”) of the target LUT 103 in the second cache area 172 (S313), and ends the valid data determination process.

In FIG. 10, if the status of the target LUT 103 is not “NOT-CACHED” (S205, No), the LUT control unit 142 determines whether or not the status of the target LUT 103 is “CACHED” (S206). If the status of the target LUT 103 is not “CACHED” (S206, No), i.e., if the status of the target LUT 103 is “READING”, the LUT control unit 142 performs the process at S206 again.

If the status of the target LUT 103 is “CACHED” (S206, Yes), as illustrated in FIG. 12, the LUT control unit 142 obtains a location (LUT cache ID) of the target LUT 103 from the entry that is obtained by the process at S204 in the cache location information 177 (S401). Then, the LUT control unit 142 translates the logical address included in the log 102 into a physical address by using the target LUT 103 stored in the obtained location in the LUT cache area 161 (S402). Then, the LUT control unit 142 determines whether or not the physical address included in the log 102 matches the physical address obtained by the translation (S403).

The fact that the physical address included in the log 102 matches the physical address obtained by the translation in the process at S403 indicates that the target user data 101 is valid, and the fact that the physical address included in the log 102 does not match the physical address obtained by the translation indicates that the target user data 101 is invalid.

If the physical address included in the log 102 does not match the physical address obtained by the translation (S403, No), the LUT control unit 142 ends the valid data determination process.

If the physical address included in the log 102 matches the physical address obtained by the translation (S403, Yes), the LUT control unit 142 determines whether or not the location where the target LUT 103 is stored is included in the second cache area 172 (S404).

If the location where the target LUT 103 is stored is included in the second cache area 172 (S404, Yes), the LUT control unit 142 performs eviction on the first cache area 171 (S405). Then, the LUT control unit 142 copies the target LUT 103 from the second cache area 172 to the first cache area 171 (S406). Specifically, the LUT control unit 142 copies the target LUT 103 from a location (LUT cache ID) indicated by the entry obtained by the process at S204 (see FIG. 10) to the location (LUT cache ID) obtained by the process at S510 (see FIG. 13) which is part of the eviction process at S405. In the process of S406, the LUT control unit 142 updates the cache content descriptor 173 in response to the copying the target LUT 103. In particular, the LUT control unit 142 registers a region number of the identified region to a location corresponding to the copying destination of the target LUT 103. The LUT control unit 142 updates the entry for the location of the target LUT 103 to the location obtained after the copying (i.e., the location obtained by the process at S510 which is part of the eviction process at S405) (S407), and ends the valid data determination process.

If the location where the target LUT 103 is stored is not included in the second cache area 172 (S404, No), i.e., if the location where the target LUT 103 is stored is included in the first cache area 171, the LUT control unit 142 performs eviction on the first cache area 171 (S408). Then, the LUT control unit 142 copies the target LUT 103 in the first cache area 171 (S409). Specifically, the LUT control unit 142 copies the target LUT 103 from the location (LUT cache ID) indicated by the entry obtained by the process at S204 (see FIG. 10) to the location (LUT cache ID) obtained by the process at S510 (see FIG. 13) which is part of the eviction process at S408. In the process of S409, the LUT control unit 142 updates the cache content descriptor 173 in the same way as the process of S406. The LUT control unit 142 updates the entry for the location of the target LUT 103 to the location obtained after the copying (i.e., the location obtained by the process at S510 which is part of the eviction process at S408) (S410), and ends the valid data determination process.

As explained using FIGS. 10 to 12, when target user data 101 is valid, an LUT 103 that includes a logical address specified when the target user data 101 is programmed and a physical address indicating a location where the target user data 101 is programmed is loaded to the first cache area 171.

In the copy process (S102), of pieces of user data 101 stored in a move source block, at least valid user data 101 is a copying target. The LUT control unit 142 notifies the NAND access unit 143 that performs a copy process, of a location of user data 101 that is determined to be valid by the valid data determination process. Specifically, when it is determined that a physical address included in a log 102 matches a physical address obtained by translation (when it is determined to be Yes at S305 in FIG. 11 or S403 in FIG. 12), the LUT control unit 142 notifies the NAND access unit 143 of a pair of a logical address specified when target user data 101 is programmed and a physical address indicating a location where the target user data 101 is programmed. The notification may be performed such that, after all pieces of valid user data 101 stored in the move source are identified, notification is transmitted to the NAND access unit 143 for all pieces of the identified valid user data 101 at once.

In the copy process (S102), the NAND access unit 143 copies the target user data 101 from the location indicated by the physical address included in the notified pair to a move destination block. When the NAND access unit 143 programs the target user data 101 in the move destination block, the NAND access unit 143 programs a new log 102 including the logical address included in the notified pair and a physical address indicating the location of the move destination. The physical address included in the notified pair is referred to as old physical address, and the physical address indicating the location of the move destination is referred to as new physical address. After copying, the NAND access unit 143 notifies the LUT control unit 142 of an LUT update request including the logical address included in the notified pair, the old physical address, and the new physical address.

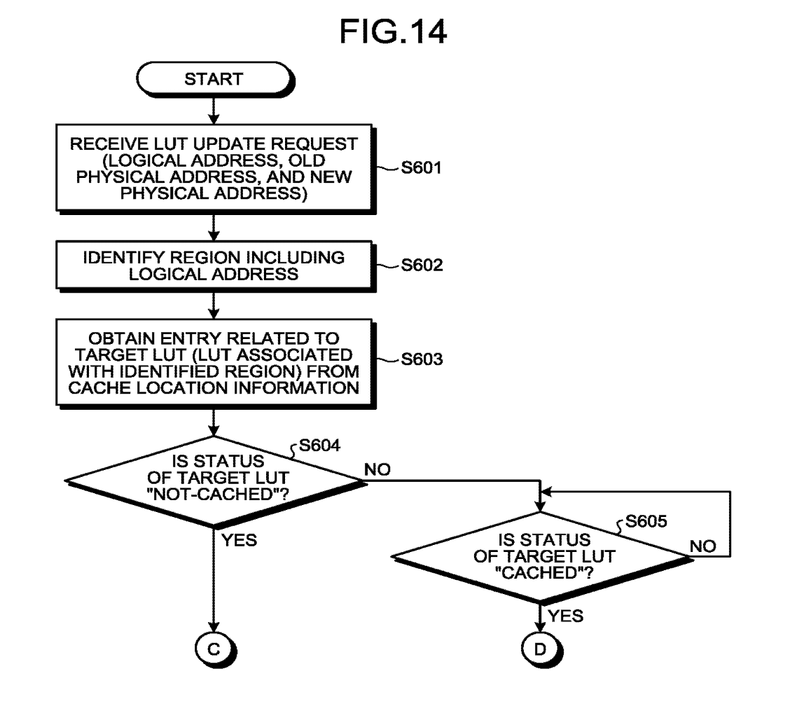

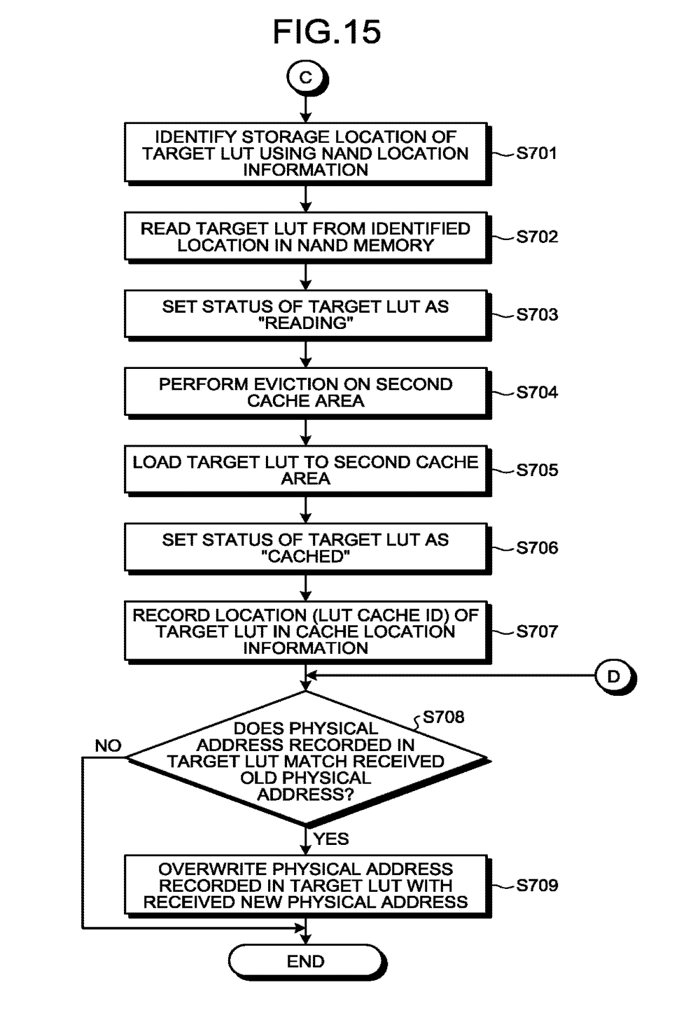

FIGS. 14 and 15 are flowcharts explaining an LUT update process for GC. Here, for simplicity, only a process for one LUT update request will be explained. In practice, an LUT update request is notified for each of all pieces of valid user data 101 stored in a move source block, and the processes of FIGS. 14 and 15 are performed for all of the notified LUT update requests.

When the LUT control unit 142 receives an LUT update request along with execution of GC (S601), the LUT control unit 142 identifies a region including a logical address that is included in the LUT update request (S602). In the explanation of FIGS. 14 and 15, an LUT 103 associated with the region identified by the process at S602 is referred to as target LUT 103. The LUT control unit 142 obtains an entry related to the target LUT 103 from the cache location information 177 (S603). The LUT control unit 142 determines whether or not the status of the target LUT 103 is “NOT-CACHED”, by referring to the obtained entry (S604).

If the status of the target LUT 103 is “NOT-CACHED” (S604, Yes), as illustrated in FIG. 15, the LUT control unit 142 identifies a location where the target LUT 103 is programmed, by referring to the NAND location information 176 (S701). The identified location is passed to the NAND access unit 143, and the NAND access unit 143 reads the target LUT 103 from the identified location (S702). The target LUT 103 read by the process at S702 is stored in a temporary area such as the RAM 16. The LUT control unit 142 sets the status of the target LUT 103 as “READING” (S703).

Then, the LUT control unit 142 performs eviction illustrated in FIG. 13 on the second cache area 172 (S704). When the LUT control unit 142 performs eviction on the second cache area 172 in the process at S704, the LUT control unit 142 obtains an LUT cache ID by the process at S510 (see FIG. 13). The LUT cache ID obtained by the process at S510 indicates a location where loading of an LUT 103 can be performed. The LUT control unit 142 loads the target LUT 103 to a location in the second cache area 172 that is indicated by the LUT cache ID obtained by the process at S510 (S705).

In response to the process at S705, the LUT control unit 142 updates the status of the target LUT 103 as “CACHED” (S706), and records, in the cache location information 177, the location (LUT cache ID “X”) of the target LUT 103 in the second cache area 172 (S707). Then, it is determined whether or not a physical address associated, by the target LUT 103 in the second cache area 172, with the logical address included in the LUT update request matches an old physical address included in the LUT update request (S708).

In FIG. 9, after the process at S101 and before the process at S103 for a target user data 101 with a logical address, if there has occurred a host write of another user data designated to the same logical address, the target user data 101 which had been determined to be valid in the process at S101 is invalid at the time point of the process at S103. The process at S708 is a process for verifying that the target user data 101 has not become invalid due to such an event. When the target user data 101 has become invalid despite the fact that target user data 101 had been determined to be valid by the process at S101, the physical address associated, by a target LUT 103 in the second cache area 172, with the logical address included in an LUT update request does not match the old physical address included in the LUT update request. When the target user data 101 had been determined to be valid by the process at S101 and is also valid at the time point of the process at S103, the physical address associated, by the target LUT 103 in the second cache area 172, with the logical address included in the LUT update request matches the old physical address included in the LUT update request.

If the physical address associated with the logical address included in the LUT update request, in the target LUT 103 in the second cache area 172 matches the old physical address included in the LUT update request (S708, Yes), the LUT control unit 142 overwrites the physical address associated, by the target LUT 103 in the second cache area 172, with the logical address included in the LUT update request, with a new physical address included in the LUT update request (S709), and ends the LUT update process for GC. If the physical address associated with the logical address included in the LUT update request, in the target LUT 103 in the second cache area 172 does not match the old physical address included in the LUT update request (S708, No), the LUT control unit 142 skips the process at S709.

In FIG. 14, if the status of the target LUT 103 is not “NOT-CACHED” (S604, No), the LUT control unit 142 determines whether or not the status of the target LUT 103 is “CACHED” (S605). If the status of the target LUT 103 is “CACHED” (S605, Yes), the LUT control unit 142 performs the process at S708.

If the status of the target LUT 103 is not “CACHED” (S605, No), i.e., the status of the target LUT 103 is “READING”, the LUT control unit 142 performs the process at S605 again.

Note that, as described above, the first cache area 171 where LUTs 103 can be loaded only by a valid data determination process which is part of garbage collection is allocated separately from the second cache area 172 where loading is performed by other processes. Therefore, by allocating an appropriate sized area as the first cache area 171, it can be guaranteed that the status of the target LUT 103 is determined to be “CACHED” in the process at S604 or S605.

For example, during a period from when an LUT 103 for one piece of user data 101 is loaded to the first cache area 171 by the process at S307, S406, or S409 until the LUT 103 for the one piece of user data 101 is referred to in the process at S103, the process at S101 is performed for other pieces of user data 101. When the size of the first cache area 171 is small, by LUTs 103 for the other pieces of user data 101 loaded to the first cache area 171, the LUT 103 for the one piece of user data 101 may be evicted from the first cache area 171. An appropriate size for preventing this is determined according to the number of pieces of user data 101 to be subjected to the process at S101 during a period from when the process at S101 is performed for the one piece of user data 101 until the process at S103 is performed.

Specifically, when the number of pieces of user data 101 to be subjected to the process at S101 during a period from when the LUT 103 for the one piece of user data 101 is loaded to the first cache area 171 in the process at S101 until the LUT 103 for the one piece of user data 101 is referred to in the process at S103, is “n”, “n” LUTs 103 at the maximum can be added to the first cache area 171 before the LUT 103 for the one piece of user data 101 is referred to in the process at S103. The appropriate size corresponds to a size capable of storing “n+1” LUTs 103. Namely, when the first cache area 171 has a size capable of storing “n+1” LUTs 103, in the process at S103 the target LUT 103 certainly has a cache hit.

Note that even when the size of the first cache area 171 is less than the size capable of storing “n+1” LUTs 103, the cache hit rate can be improved compared to the case in which a cache area is used without distinguishing between process of garbage collection and processes other than the garbage collection.

As described above, according to the embodiment of the present invention, the RAM 16 includes the first cache area 171 which is a cache area where only LUTs 103 having been used for garbage collection are cached. The processor 141 loads only an LUT 103 having been used in a valid data determination process, to the first cache area 171. The LUT 103 having been used in the valid data determination process is, in other words, an LUT 103 including translation information having been used in the valid data determination process. By this, eviction from the first cache area 171 is performed in response to only the loading of an LUT 103 having been used in the valid data determination process, and is not performed in response to any other process such as a host write process or a host read process. Therefore, the probability that a target LUT 103 has a cache hit in an LUT update process for GC improves.

Note that using an LUT 103 in a valid data determination process includes at least referring to the LUT 103 in the valid data determination process. In the valid data determination process, in order to determine whether user data 101 stored in a move source block is valid or invalid, the processor 141 obtains and refers to an LUT 103 associated with a region including a logical address that is specified when the user data 101 is transmitted from the host 2. If it is determined after the reference that the user data 101 is valid, the processor 141 loads the LUT 103 associated with the region including the logical address that is specified when the user data 101 determined to be valid is transmitted from the host 2, to at least the first cache area 171. The processor 141 may load all LUTs 103 having been referred to in the valid data determination process, to the first cache area 171.

In addition, although the explanation is made such that translation information is transferred in units of regions between the NAND memory 10 and the cache area, the unit of transfer of the translation information does not need to be a region. For example, cluster-by-cluster translation information may be transferred between the NAND memory 10 and the cache area. In other words, the magnitude of a data unit to be loaded to the cache area can be designed in any unit.

In addition, in an LUT update process for GC, the processor 141 can obtain a target LUT 103 from the first cache area 171. By this, the frequency of a process of reading a target LUT 103 from the NAND memory 10 is reduced.

In addition, in a host write process, the processor 141 loads an LUT 103 to the second cache area 172. In a valid data determination process, when a target LUT 103 is cached in the second cache area 172, the processor 141 refers to the target LUT 103 cached in the second cache area 172. When it is determined after the reference that user data 101 is valid, the processor 141 moves the target LUT 103 from the second cache area 172 to the first cache area 171 (S406). Even when the memory system 1 thus includes the second cache area 172 which is a cache area for processes other than garbage collection, upon garbage collection the target LUT 103 is loaded to the first cache area 171. Therefore, the probability that a target LUT 103 has a cache hit in an LUT update process for GC improves.

In addition, in the valid data determination process, when the target LUT 103 is cached in the second cache area 171, the processor 141 refers to the target LUT 103 cached in the first cache area 172. The first cache area 172 is a FIFO structure, and when it is determined after the reference that the user data 101 is valid, the processor 141 moves the target LUT 103 to a location indicated by the first FIFO pointer 174 (the logical tail of the first cache area 172 serving as a FIFO structure) (S409). Namely, when a condition that an LUT 103 associated with the same region is added to the first cache area 172 is satisfied a plurality of times during a period during which a valid data determination process is sequentially performed for each piece of user data 101 stored in a transfer source block, the processor 141 moves the LUT 103 to the logical tail of the first cache area 171 every time the condition is satisfied. For example, when two pieces of user data 101 designated to different logical addresses that belong to the same region are retained in a move source block, an LUT 103 associated with the region is referred to a plurality of times. By moving the LUT 103 in the above-described manner, the probability that the LUT 103 has a cache hit improves when an LUT update process for GC is performed for one of the two pieces of user data 101 that is programmed later.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, the memory system comprising:
a nonvolatile first memory;
a second memory including a first cache area in which caching is performed in units of a data-unit, the size of the data-unit being equal to a size of cache line;
an interface that receives first data designated to a logical address from the host; and
a processor that transfers the first data and translation information for the first data into the first memory, and performs garbage collection, the translation information for the first data being information that associates the logical address with a location where the first data is programmed in the first memory, wherein
the garbage collection includes: a first process of determining whether second data is in a valid state or an invalid state on the basis of at least translation information for the second data, the second data corresponding to the first data in the first memory; a second process of copying third data within the first memory, the third data corresponding to the second data determined to be in the valid state; and a third process of updating translation information for the third data, and
the processor caches, in the first cache area, only a data-unit including translation information for the first process.

2. The memory system according to claim 1, wherein
the valid state includes
a state of a piece of data designated to a logical address, no other pieces of data designated to the same logical address existing in the memory system, and
a state of a piece of data designated to a logical address, the piece of data being received last among a plurality of data designated to the same logical address, and
the invalid state includes
a state of a piece of data designated to a logical address, the piece of data not being received last among a plurality of data designated to the same logical address.

3. The memory system according to claim 1, wherein in the third process, the processor obtains the translation information for the third data from the first cache area.

4. The memory system according to claim 1, wherein
the second memory further includes a second cache area, and
the processor caches the translation information for the first data into the second cache area when the first data is programmed in the first memory.

5. The memory system according to claim 4, wherein in the first process, the processor determines whether or not the translation information for the second data is cached in the second cache area, and in a case where the translation information for the second data is cached in the second cache area, the processor uses the translation information for the second data cached in the second cache area.

6. The memory system according to claim 5, wherein
caching is performed in units of a data-unit into the second cache area, and
in the first process, in a case where the processor determines that the translation information for the second data is cached in the second cache area and the second data is in the valid state, the processor moves a data-unit including the translation information for the second data from the second cache area to the first cache area.

7. The memory system according to claim 1, wherein in the first process, the processor determines whether or not the translation information for the second data is cached in the first cache area, and in a case where the translation information for the second data is cached in the first cache area, the processor uses the translation information for the second data cached in the first cache area.

8. The memory system according to claim 7, wherein
the first cache area has a FIFO (First In First Out) structure, and
in the first process, in a case where the processor determines that the translation information for the second data is cached in the first cache area and the second data is in the valid state, the processor moves a data-unit including the translation information for the second data to a tail of the FIFO structure.

9. The memory system according to claim 1, wherein the processor caches, into the first cache area, only a data-unit including the translation information for the third data.

10. The memory system according to claim 1, wherein
the processor programs a log for the first data into the first memory in response to the programming of the first data into the first memory, the log for the first data representing an association between the logical address and the location where the first data is programmed in the first memory, and
in the first process, the processor reads a log for the second data from the first memory and determines whether the second data is in the valid state or in the invalid state, on the basis of whether or not the translation information for the second data matches the log for the second data.

11. The memory system according to claim 1, wherein
the first cache area has a size of n of data-units,
the n is equal to or larger than the maximum number of data-units which are loaded in the first cache area from when loading a data-unit in the first process until obtaining of the data-unit in the third process.

12. A control method for a memory system including a first memory and a second memory, the first memory being nonvolatile, the control method comprising:
receiving first data designated to a logical address from a host;
transferring the first data and translation information for the first data into the first memory, the translation information for the first data being information that associates the logical address with a location where the first data is programmed in the first memory;
allocating a first cache area in the second memory; and
performing garbage collection, wherein
the performing garbage collection includes:
determining whether second data is in a valid state or in an invalid state on the basis of at least translation information for the second data, the second data corresponding to the first data stored in the first memory;
caching, in the first cache area, only a data-unit including translation information for the determining;
copying third data within the first memory, the third data corresponding to the second data determined to be in the valid state;
reading translation information for the third data from the first cache area; and
updating the read translation information for the third data.

13. The control method according to claim 12, wherein
the valid state includes
a state of a piece of data designated to a logical address, no other pieces of data designated to the same logical address existing in the memory system, and
a state of a piece of data designated to a logical address, the piece of data being received last among a plurality of data designated to the same logical address, and
the invalid state includes
a state of a piece of data designated to a logical address, the piece of data not being received last among a plurality of data designated to the same logical address.

14. The control method according to claim 12, further comprising:
further allocating a second cache area in the second memory; and
caching the translation information for the first data into the second cache area when the first data is programmed in the first memory.

15. The control method according to claim 14, wherein
the determining further includes:
determining whether or not the translation information for the second data is cached in the second cache area; and
using the translation information for the second data cached in the second cache area when the translation information for the second data is cached in the second cache area.

16. The control method according to claim 15, further comprising moving, in a case where it is determined that the translation information for the second data is cached in the second cache area and the second data is in the valid state, a data-unit including the translation information for the second data from the second cache area to the first cache area.

17. The control method according to claim 12, wherein
the determining further includes:
determining whether or not the translation information for the second data is cached in the first cache area, and
using, in a case where the translation information for the second data is cached in the first cache area, the translation information for the second data cached in the first cache area.

18. The control method according to claim 17, wherein
the first cache area has a FIFO structure, and
the control method further comprises moving, in a case where it is determined that the translation information for the second data is cached in the first cache area and the second data is in the valid state, a data-unit including the translation information for the second data to a tail of the FIFO structure, the translation information being cached in the first cache area.

19. The control method according to claim 12, wherein the caching is caching only a data-unit including the translation information for the third data into the first cache area.

20. The control method according to claim 12, further comprising:
programming a log for the first data into the first memory in response to the programming of the first data into the first memory, the log for the first data representing an association between the logical address and the location where the first data is programmed in the first memory, wherein
the determining further includes:
reading a log for the second data from the first memory; and
determining whether or not the second data is in the valid state or in the invalid state, based on whether the translation information for the second data matches the log for the second data.
